(19) United States
(12) Patent Application Publication
(10) Pub. No.: US 2010/0246413 A1
(43) Pub. Date: Sep. 30, 2010

(54) TRANSMISSION LINE SIMULATOR

(75) Inventors: James T. Schley-May, Nevada City, CA (US); Curtis M. Allen, Grass Valley, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: 2WIRE, INC., San Jose, CA (US)

(21) Appl. No.: 12/415,737

(22) Filed: Mar. 31, 2009

(51) Int. Cl. H04L 12/26

(52) U.S. Cl. 370/248

(57) ABSTRACT

A method and apparatus to simulate a length of telecommunications line. One or more bi-directional constant input impedance low pass or pole/zero filters are coupled in series with an attenuator to simulate a length of telecommunications line. The one or more filters are used to approximate the transfer function of the length of telecommunications line.

### TECHNICAL FIELD

This invention relates to the field of transmission lines and, in particular, to simulating the performance of a transmission line.

### BACKGROUND

Many modern communications systems employ a twisted wire pair using differential signaling to transmit data. Among the communications systems in this category are telecommunications systems such as the various types of Digital Subscriber Line (xDSL), and other digital carrier systems. xDSL may include, for example, asymmetric digital subscriber line (ADSL), high-speed digital subscriber line (HDSL) and very high-speed digital subscriber line (VDSL) systems.

In the development and testing of xDSL or other communications systems, it may be useful to simulate the behavior of the twisted pair transmission lines. Typically a ground referenced transmission line is modeled as a series resistor, inductor, and capacitor (RLC) circuit. FIG. 1A illustrates a conventional RLC circuit that may be used to model a transmission line. FIG. 1B illustrates an equivalent balanced differential version of the RLC circuit which is required for twisted pair emulators. When multiple RLC circuits are cascaded in series, they may accurately model a transmission line.

In a transmission line simulator, the physical length which each individual RLC circuit represents, affects the accuracy of the model. The shorter the length that each section represents, the more accurate the model will be for a given overall target model length. Additionally, as the upper frequency limit of the model increases, it is necessary to shorten the length that each section represents. Thus to achieve high accuracy at high frequencies, the model must be made up of many sections, each representing a very small length of the actual transmission line.

In one example using an ADSL system, in order to accurately model a twisted pair transmission line with an upper limit of approximately 2 megahertz (MHz), each section of the model must represent a length of approximately 50 feet (ft). The RLC circuit of FIG. 1B is a theoretical ideal simplification. In reality, each section may include approximately 15 actual components. Thus to simulate a 3000 ft twisted pair transmission line, approximately 900 total components would be required. In a VDSL system where the upper limit of the frequency range is extended to approximately 12 MHz, the number of components would have to be scaled to approximately 5400 total components.

### BRIEF DESCRIPTION OF THE DRAWINGS

The present invention is illustrated by way of example, and not by way of limitation, in the figures of the accompanying drawings.

FIGS. 1A and 1B illustrate a convention LC circuit used for modeling a transmission line.

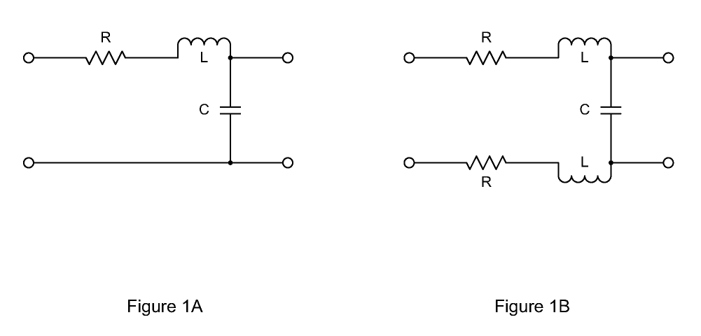

FIG. 2 is a block diagram illustrating an embodiment of a discrete multi-tone system.

FIG. 3A illustrates a block diagram of a bi-directional line simulator with constant input impedance according to one embodiment of the present invention.

FIG. 3B illustrates a block diagram of a bi-directional line simulator with constant input impedance according to one embodiment of the present invention.

FIG. 4 illustrates a block diagram of a bi-directional line simulator with constant input impedance according to one embodiment of the present invention.

FIGS. 5A and 5B illustrate a circuit diagram of one section of a bi-directional line simulator with constant input impedance in single ended and balanced forms according to one embodiment of the present invention.

FIG. 6 illustrates a circuit diagram of a portion of a bi-directional differential line simulator with constant input impedance according to one embodiment of the present invention.

FIGS. 7A and 7B illustrate a bi-directional constant impedance low pass tee form filter in single ended and balanced forms according to one embodiment of the present invention.

FIGS. 8A and 8B illustrate a bi-directional constant impedance low pass bridged-tee form filter in single ended and balanced forms according to one embodiment of the present invention.

FIGS. 9A and 9B illustrate a bi-directional constant impedance pole/zero pi form filter in single ended and balanced forms according to one embodiment of the present invention.

FIGS. 10A and 10B illustrate a bi-directional constant impedance pole/zero tee form filter in single ended and balanced forms according to one embodiment of the present invention.

FIGS. 11A and 11B illustrate a bi-directional constant impedance pole/zero bridged-tee form filter in single ended and balanced forms according to one embodiment of the present invention.

FIG. 12 is a flow diagram illustrating designing a line simulator according to one embodiment of the present invention.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

The following detailed description includes several modules, which will be described below. These modules may be implemented by hardware components, such as logic, or may be embodied in machine-executable instructions, which may be used to cause a general-purpose or special-purpose processor programmed with the instructions to perform the operations described herein. Alternatively, the operations may be performed by a combination of hardware and software.

Embodiments of a method and apparatus are described to simulate a length of telecommunications line. In one embodiment, one or more bi-directional constant input impedance low pass filters are coupled in series with an attenuator to simulate a length of telecommunications line. The one or more filters are used to approximate the transfer function of the length of telecommunications line.

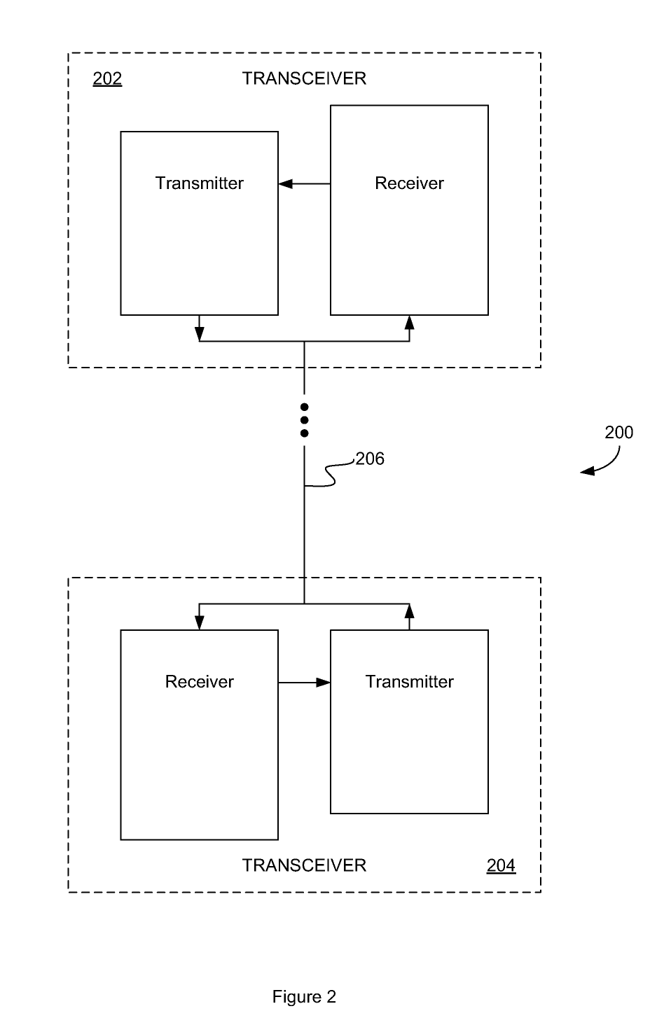

FIG. 2 is a block diagram illustrating an embodiment of a discrete multi-tone system. The discrete multi-tone system 200, such as a Digital Subscriber Line (DSL) based network, may have two or more transceivers 202 and 204, such as a DSL modem in a set top box. In one embodiment, the set top box may be a stand-alone DSL modem. In one embodiment, for example, the set top box employs a DSL modem along with other media components to combine television (Internet Protocol TV or satellite) with broadband content from the Internet to bring the airwaves and the Internet to an end user's TV set. Multiple carrier communication channels may communicate a signal to a residential home. The home may have a home network, such as an Ethernet. The home network may either use the multiple carrier communication signal directly, or convert the data from the multiple carrier communication signal. The set top box may also include, for example, an integrated Satellite and Digital Television Receiver, High-Definition Digital Video Recorder, Digital Media Server and other components.

The first transceiver 202, such as a Discrete Multi-Tone transmitter, transmits and receives communication signals from the second transceiver 204 over a transmission medium 206, such as a telephone line. The discrete multi-tone system 200 may include a central office, multiple distribution points, and multiple end users. The central office may contain the first transceiver 202 that communicates with the second transceiver 204 at an end user's location.

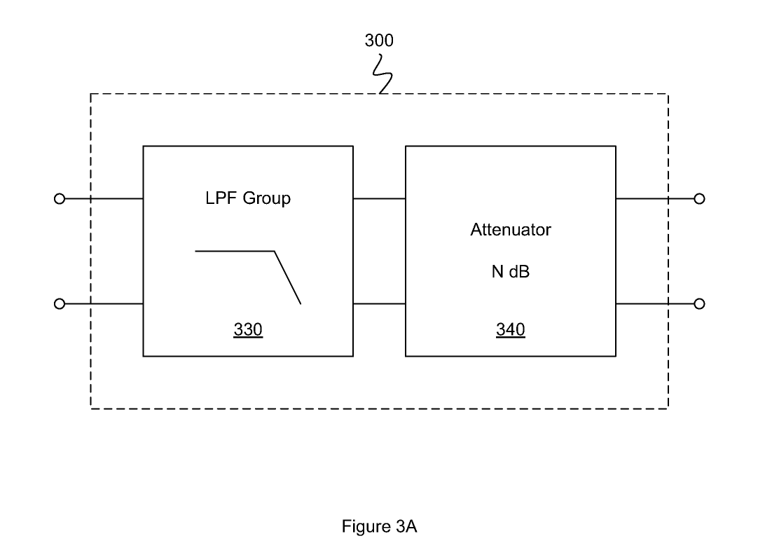

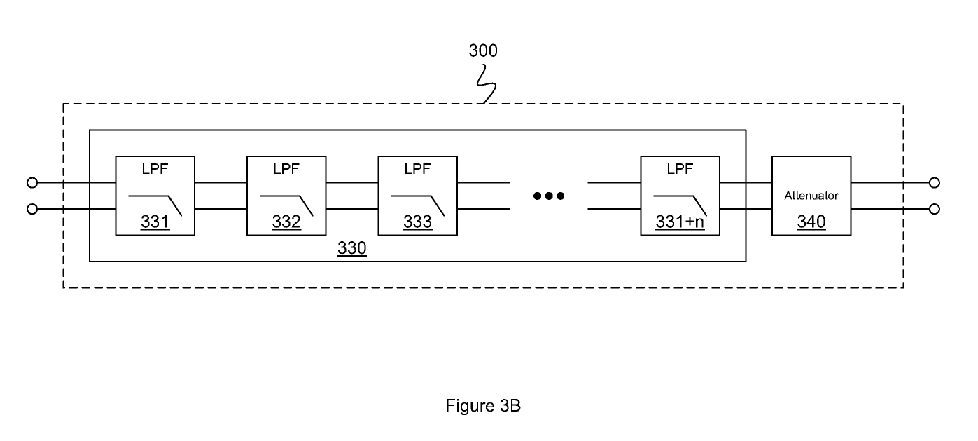

FIG. 3A illustrates a block diagram of a bi-directional line simulator with constant input impedance according to one embodiment of the present invention. Line simulator 300 may be used to model the behavior of transmission medium 206 discussed above with respect to FIG. 2. Line simulator 300 includes low-pass filter (LPF) group 330 and attenuator 340. LPF group 330 may include one or more LPF sections, each section having constant input and output impedance. In alternative embodiments, filters having other responses (e.g., pole/zero) may be used. LPF group 330 and attenuator 340 are coupled in series such that their order does not matter. For example, attenuator 340 may be placed before LPF group 330, after LPF group 330 or in the middle of LPF group 330. Line simulator 300 has constant input and output impedance such that its behavior will be identical whether looked at from either side.

FIG. 3B illustrates a block diagram of a bi-directional line simulator with constant input impedance according to one embodiment of the present invention. Line simulator 300 includes LPF group 330 and attenuator 340. In this embodiment, LPF group 330 includes LPF sections 331 to 331+n, where n+1 is the number of LPF sections used in the simulator design. Each of the LPF sections 331 to 331+n has a constant input and output impedance. In this embodiment, the impedance is equal to approximately 100 ohms. Attenuator 340 also has a constant input and output impedance equal to approximately 100 ohms. In an alternative embodiment, the impedance is equal to some other value.

Each LPF section 331 to 331+n, if driving into or driven from a 100 ohm impedance, is non-interacting with its neighbors. As a result, the ordering of the LPF sections 331 to 331+n is not critical. Each individual section is symmetric and the whole LPF group 330, with all sections, is also symmetric. Thus, LPF sections 331 to 331+n may be ordered in any manner.

Each of LPF sections 331 to 331+n includes a first order low-pass filter having a single pole. A pole exists at the frequency for which the magnitude response of the LPF transfer function is −3 decibels (dB). The transfer function is a mathematical representation of the relation between the output and the input of the filter. The location of the pole of each LPF section 331 to 331+n is used to approximate the transfer function of the length of telecommunication line being simulated. The transfer function of the length of telecommunication line being simulated can be calculated using formulas well-known to one of ordinary skill in the art or alternatively by measuring the performance of the actual length of telecommunication line. This transfer function is the target response for the line simulator. Once the target response is known, the remaining variables in the line simulator are the number of LPF sections and the location of the pole of each LPF section. The number of LPF sections and their pole locations are adjusted until the response of the line simulator fits the target response to within a desired level of accuracy. In general, the higher the number of LPF sections used in the simulator, the closer the simulator response will be to the target response.

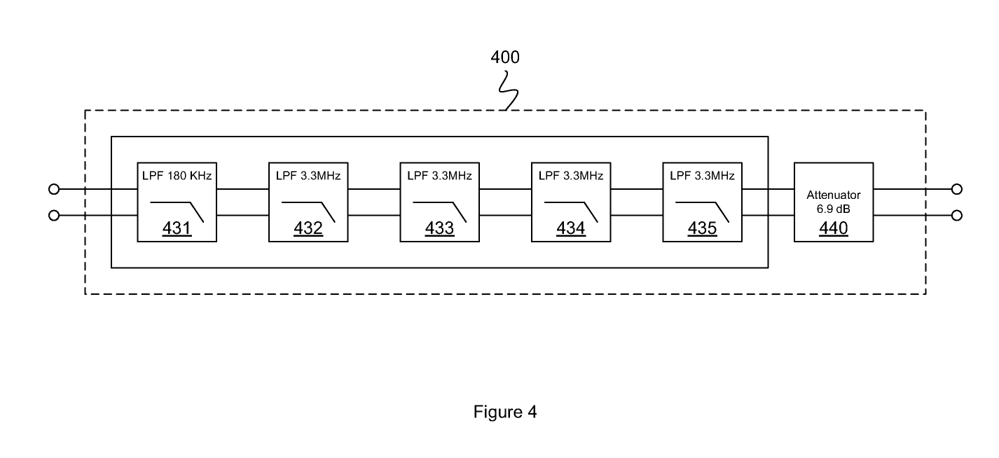

In one example, depicted in FIG. 4, the length of telecommunication line to be simulated is a 2900 foot length of 26 American Wire Gauge (AWG) twisted pair cable. In this embodiment, the line simulator 400 for this target line includes five LPF sections. Four of the LPF sections 432-435 are identical and have a pole at 3.3 MHz. The fifth LPF section 431 has a pole at 180 kilohertz (KHz). As discussed above, the LPF sections are completely symmetrical and may be arranged in any order. The attenuator 440 has an attenuation factor of 6.9 dB. This particular combination of LPF sections and the attenuator results in a curve fit to within a few decibels over the frequency range of 20 KHz to 20 MHz. This approximation is sufficient for many line simulation applications. In an alternative embodiment, the accuracy of the approximation may be increased by adding additional LPF sections. Alternative embodiments may also use LPF sections with poles in different locations. In other alternative embodiments, filters with other response types (e.g., pole/zero) may be used.

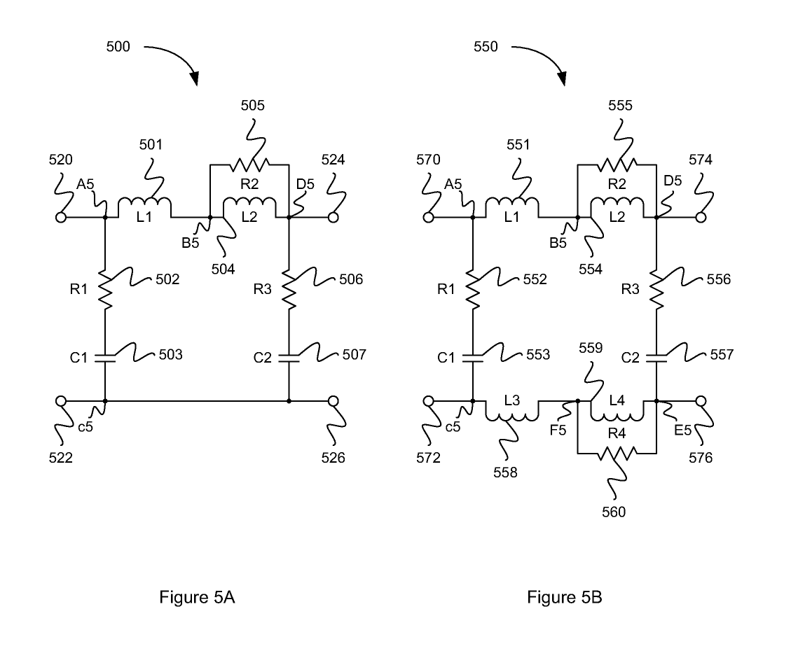

FIG. 5A illustrates a circuit diagram of one section of a bi-directional line simulator with constant input impedance according to one embodiment of the present invention. Circuit 500 includes inductors 501 and 504, resistors 502, 505 and 506, capacitors 503 and 507, input lines 520 and 522, and output lines 524 and 526. In one embodiment, inductor 501 is coupled between a first node A5 and a second node B5. Resistor 502 and capacitor 503 are coupled in series between the first node A5 and a third node C5. Inductor 504 and resistor 505 are coupled in parallel between the second node B5 and a fourth node D5. Resistor 506 and capacitor 507 are coupled in series between the fourth node D5 and the third node c5. Input line 520 is coupled to the first node A5, input line 522 is coupled to the third node c5, output line 524 is coupled to the fourth node D5, and output line 526 is coupled to the third node c5.

In a DSL system the driving and load impedances (z₀) may be approximately 100 ohms+/−10 percent. Thus, in one embodiment, the constant input impedance of each LPF section is approximately 100 ohms. In an alternative embodiment another value for z₀ is used. Since z₀ is already known, the values of the capacitors and inductors of each section will depend solely on the pole location for that section. As discussed above, the pole location is chosen so that the response of the LPF sections taken together approximate the target response to within a given threshold.

In one embodiment, the values of the components in circuit 500 may be chosen as follows. The value of the first resistor 502 equals the value of the third resistor 506 which equals:

R1=R3=z₀ (1)

where z₀ is the constant input impedance.
The value of the second resistor 505 equals:

$$R 2 = \frac{{z}_{0}}{2} \qquad ( 2 )$$

The values of the two inductors 501 and 504 both equal:

$$L 1 = L 2 = \frac{{z}_{0}}{2 \cdot {ω}_{c}} \qquad ( 3 )$$

where ω_{c} is the desired pole frequency.
The value of the first capacitor 503 equals the value of the second capacitor 507 which equals:

$$C 1 = C 2 = \frac{1}{2 \cdot {z}_{0} \cdot {ω}_{c}} \qquad ( 4 )$$

These values result in a transfer response (H(s)) for the LPF section as shown in equation 5.

$$H ( s ) = \frac{1}{1 + \frac{s}{{ω}_{c}}} \qquad ( 5 )$$

The filter is bi-directional and thus, the input impedance looking into the filter from either direction is equal to z₀. This is a constant input impedance value and, therefore, it is not dependent on the filter response. The line simulator is symmetric and thus, the input impedance looking into the filter from either direction is equal to z₀. This is a constant input impedance value and therefore, it is not dependent on the filter response.

This allows multiple LPF sections to be used in cascade with complete freedom to set any of the pole frequencies arbitrarily without interaction.

FIG. 5B illustrates a circuit diagram of one section of a bi-directional differential line simulator with constant input impedance according to one embodiment of the present invention. Circuit 550 includes inductors 551, 554, 558 and 559, resistors 552, 555, 556 and 560, capacitors 553 and 557, input lines 570 and 572, and output lines 574 and 576. In one embodiment, inductor 551 is coupled between a first node A5 and a second node B5. Resistor 552 and capacitor 553 are coupled in series between the first node A5 and a third node c5. Inductor 554 and resistor 555 are coupled in parallel between the second node B5 and a fourth node D5. Resistor 556 and capacitor 557 are coupled in series between the fourth node D5 and a fifth node E5. Inductor 558 is coupled between the third node c5 and a sixth node F5. Inductor 559 and resistor 560 are coupled in parallel between the fifth node E5 and the sixth node F5. Input line 570 is coupled to the first node A5, input line 572 is coupled to the third node c5, output line 574 is coupled to the fourth node D5, and output line 576 is coupled to the fifth node E5.

One or more LPF sections shown in FIG. 5B may be used in a bi-directional line simulator with constant input impedance as shown in FIG. 3. Each of the LPF sections has a bi-directional constant input impedance. In a DSL system, the input impedance may be approximately 100 ohms+/−10 percent. Thus, in one embodiment, the constant input impedance (z₀) of each LPF section is approximately 100 ohms. Since z₀ is already known, the values of the capacitors and inductors of each section will depend solely on the pole location for that section. As discussed above, the pole location is chosen so that the response of the LPF section(s) approximates the target response to within a given threshold.

In one embodiment, the values of the components in circuit 550 may be chosen in a manner similar to that discussed above with respect to FIG. 5A. The component values for FIG. 5B will be similar to those in FIG. 5A with several exceptions. The first inductor 551 has an inductance value that is one half the value of inductor 501. The second, third, and fourth inductors 554, 558 and 559 have inductance values equal to the first inductor 551. The second resistor 555 has a resistance value that is one half the value of resistor 505. The fourth resistor 560 has a resistance value equal to the second resistor 555. The values of resistors 552, 556 and capacitors 553, 557 remain the same as components 502, 506, 503 and 507 respectively. Given these component values, the transfer function will be the same as shown above in equation 5.

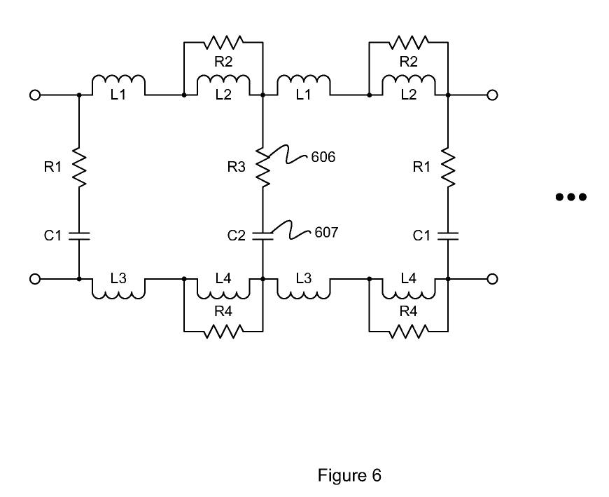

One or more LPF sections as shown in FIG. 5B may be cascaded in series to approximate the target response of a length of telecommunications line. Since the sections are in cascade and are symmetric, they may be placed in any order. In one embodiment shown in FIG. 6, identical sections (i.e. LPF sections having the same pole location and component values) are ordered together so that their equal shunt resistances (e.g. 552 or 556) and capacitances (e.g. 553 or 557) are combined into one resistor 606 in series with one capacitor 607. In alternative embodiments, only the resistors or capacitors are combined.

In the example discussed above with respect to FIG. 4, five LPF sections were used to model a 2900 foot long telecommunications cable. Using the LPF structure discussed with regard to FIG. 5B, each LPF section includes ten electric components. An electric component may be any linear or non-linear, passive or active electric component. For example, an electric component may include a resistor, an inductor, a capacitor, a diode or like component other than a wire, line, or trace. The attenuator includes five electric components resulting in a total component count of 55 components for the line simulator. The simulator design of FIG. 4 uses a greatly reduced component count to achieve a similar magnitude response as conventional line simulators and allows for simulating a behavior of a length of telecommunications line using electric components in a ratio of less than five electric components for every 50 feet of the telecommunications line being simulated. The design of FIG. 4 also uses fewer inductors than conventional line simulators and is therefore less susceptible to noise pickup. Using the structure of FIG. 6 could result in the use of even less electric components. A traditional line simulator for the same simulated line would have a total of approximately 5220 electric components. The simulator design can be tailored to simulate a plurality of line lengths including virtually any line length. Since the LPF sections have constant impedance and are non-interacting, modular designs can be made for selectable line lengths. By simulating the transfer function of the entire telecommunications line length with five LPF sections and an attenuator, the method and apparatus described herein uses at least an order of magnitude fewer components than conventional line simulators.

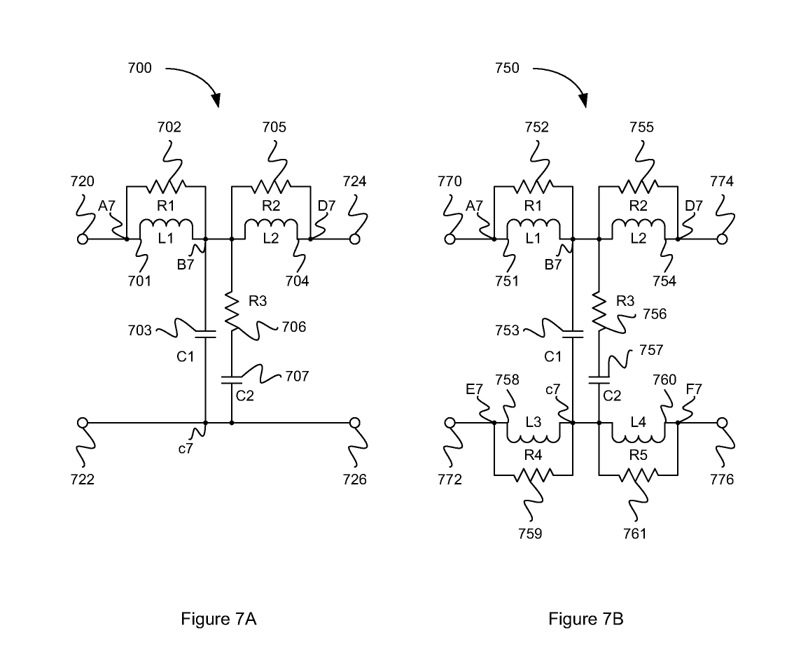

FIGS. 7A and 7B illustrate a bi-directional constant impedance low pass tee form filter in single ended and balanced forms according to one embodiment of the present invention. Circuit 700 includes inductors 701 and 704, resistors 702, 705 and 706, capacitors 703 and 707, input lines 720 and 722, and output lines 724 and 726. In one embodiment, inductor 701 and resistor 702 are coupled in parallel between a first node A7 and a second node B7. Capacitor 703 and resistor 706 and capacitor 707, coupled in series, are coupled in parallel between the second node B7 and a third node c7. Inductor 704 and resistor 705 are coupled in parallel between the second node B7 and a fourth node D7. Input line 720 is coupled to the first node A7, input line 722 is coupled to the third node c7, output line 724 is coupled to the fourth node D7, and output line 726 is coupled to the third node c7.

In one embodiment, the values of the components in circuit 700 may be chosen as follows. The value of the first resistor 702 equals the value of the second resistor 705 which equals:

R1=R2=z₀ (6)

where z₀ is the constant input impedance.
The value of the third resistor 706 equals:

R3=2·z₀ (7)

The values of the two inductors 701 and 704 both equal:

$$L 1 = L 2 = \frac{{z}_{0}}{2 \cdot {ω}_{c}} \qquad ( 8 )$$

where ω_{c} is the desired pole frequency.
The value of the first capacitor 703 equals the value of the second capacitor 707 which equals:

$$C 1 = C 2 = \frac{1}{2 \cdot {z}_{0} \cdot {ω}_{c}} \qquad ( 9 )$$

These values result in a transfer response (H(s)) for the LPF section as shown in equation 10.

$$H ( s ) = \frac{1}{1 + \frac{s}{{ω}_{c}}} \qquad ( 10 )$$

The filter is bi-directional and thus, the input impedance looking into the filter from either direction is equal to z₀. This is a constant input impedance value and, therefore, it is not dependent on the filter response.

This allows multiple LPF sections to be used in cascade with complete freedom to set any of the pole frequencies arbitrarily without interaction.

Referring to FIG. 7B, circuit 750 includes inductors 751, 754, 758 and 760, resistors 752, 755, 756, 759 and 761, capacitors 753 and 757, input lines 770 and 772, and output lines 774 and 776. In one embodiment, inductor 751 and resistor 752 are coupled in parallel between a first node A7 and a second node B7. Capacitor 753 and resistor 756 and capacitor 757, coupled in series, are coupled in parallel between the second node B7 and a third node c7. Inductor 754 and resistor 755 are coupled in parallel between the second node B7 and a fourth node D7. Inductor 758 and resistor 759 are coupled in parallel between the third node c7 and a fifth node E7. Inductor 760 and resistor 761 are coupled in parallel between the third node c7 and a sixth node F7. Input line 770 is coupled to the first node A7, input line 772 is coupled to the fifth node E7, output line 774 is coupled to the fourth node D7, and output line 776 is coupled to the sixth node F7.

In one embodiment, the values of the components in circuit 750 may be chosen in a manner similar to that discussed above with respect to FIG. 7A. The component values for FIG. 7B will be similar to those in FIG. 7A with several exceptions. The first inductor 751 has an inductance value that is one half the value of inductor 701. The second, third, and fourth inductors 754, 758 and 760 have inductance values equal to the first inductor 751. Resistors 752, 755, 759 and 761 have resistance values that equal to one half the value of resistor 702. The values of resistor 756 and capacitors 753 and 757 remain the same as components 706, 703 and 707 respectively. Given these component values, the transfer function will be the same as shown above in equation 10.

The bi-directional constant impedance low pass tee form filter illustrated in FIGS. 7A and 7B has a resistor in parallel with each inductor in the structure. At the limit (i.e., at infinite frequency), inductors ideally have an infinite impedance. Nevertheless, real physical inductors may have a relatively small capacitance across their windings. Thus, the inductors behave like capacitors, not inductors, at infinite frequency. This may cause what is known as parallel resonance or self resonance, which can contribute to problems with many filters in practice.

In either form of the tee structure above however, the effect of parallel resonance is mitigated by the resistor in parallel with each inductor. The resistor impedance is so much smaller than that of the parasitic capacitance (at any frequency of interest) that the latter has nearly zero effect on the network's frequency response.

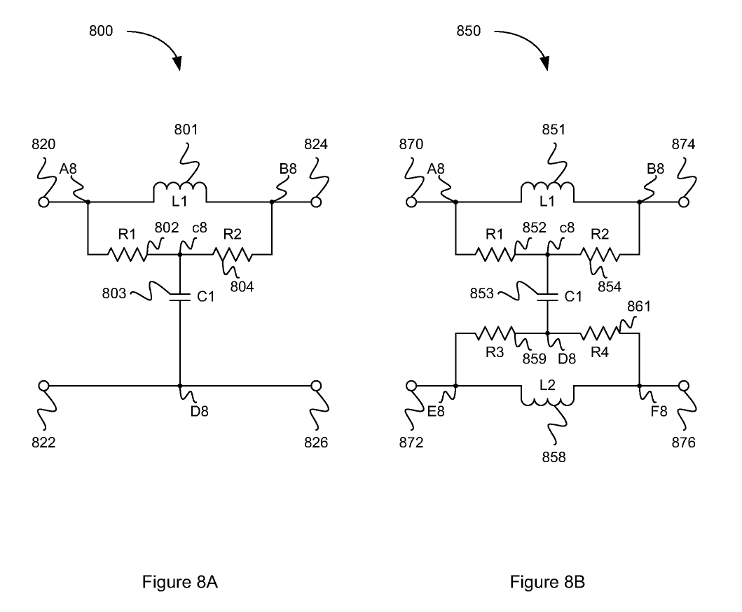

FIGS. 8A and 8B illustrate a bi-directional constant impedance low pass bridged-tee form filter in single ended and balanced forms according to one embodiment of the present invention. Circuit 800 includes inductor 801, resistors 802 and 804, capacitor 803, input lines 820 and 822, and output lines 824 and 826. In one embodiment, inductor 801 is coupled between a first node A8 and a second node B8. Resistor 802 is coupled between the first node A8 and a third node c8. Capacitor 803 is coupled between the third node c8 and a fourth node D8. Resistor 804 is coupled between the second node B8 and the third node c8. Input line 820 is coupled to the first node A8, input line 822 is coupled to the fourth node D8, output line 824 is coupled to the second node B8, and output line 826 is coupled to the fourth node D8.

In one embodiment, the values of the components in circuit 800 may be chosen as follows. The value of the first resistor 802 equals the value of the second resistor 804 which equals:

R1=R2=z₀ (11)

where z₀ is the constant input impedance.
The value of the inductor 801 equals:

$$L 1 = \frac{{z}_{0}}{{ω}_{c}} \qquad ( 12 )$$

where ω_{c} is the desired pole frequency.
The value of the capacitor 803 equals:

$$C 1 = \frac{1}{{z}_{0} \cdot {ω}_{c}} \qquad ( 13 )$$

These values result in a transfer response (H(s)) for the LPF section as shown in equation 14.

$$H ( s ) = \frac{1}{1 + \frac{s}{{ω}_{c}}} \qquad ( 14 )$$

The filter is bi-directional and thus, the input impedance looking into the filter from either direction is equal to z₀. This is a constant input impedance value and, therefore, it is not dependent on the filter response.

This allows multiple LPF sections to be used in cascade with complete freedom to set any of the pole frequencies arbitrarily without interaction.

Referring to FIG. 8B, circuit 850 includes inductors 851 and 858, resistors 852, 854, 859 and 861, capacitor 853, input lines 870 and 872, and output lines 874 and 876. In one embodiment, inductor 851 is coupled between a first node A8 and a second node B8. Resistor 852 is coupled between the first node A8 and a third node c8. Capacitor 853 is coupled between the third node c8 and a fourth node D8. Resistor 854 is coupled between the second node B8 and the third node c8. Resistor 859 is coupled between the fourth node D8 and a fifth node E8. Resistor 861 is coupled between the fourth node D8 and a sixth node F8. Inductor 858 is coupled between the fifth node E8 and the sixth node F8. Input line 870 is coupled to the first node A8, input line 872 is coupled to the fifth node E8, output line 874 is coupled to the second node B8, and output line 876 is coupled to the sixth node F8.

In one embodiment, the values of the components in circuit 850 may be chosen in a manner similar to that discussed above with respect to FIG. 8A. The component values for FIG. 8B will be similar to those in FIG. 8A with several exceptions. The first inductor 851 has an inductance value that is one half the value of inductor 801. The second inductor 858 has an inductance values equal to the first inductor 851. Resistors 852, 854, 859 and 861 have resistance values that equal to one half the value of resistor 802. The value of capacitor 853 remains the same as capacitor 803. Given these component values, the transfer function will be the same as shown above in equation 14.

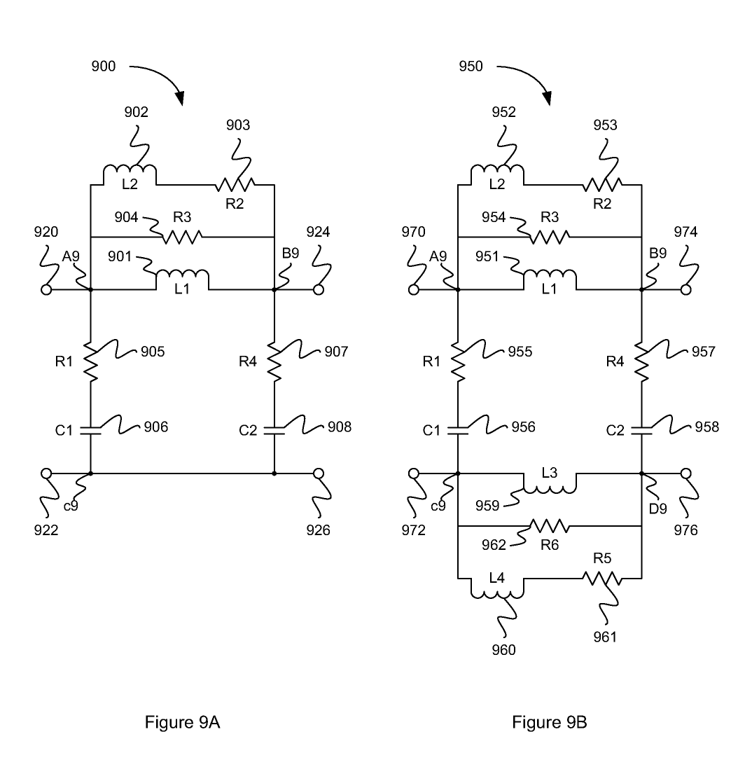

FIGS. 9A and 9B illustrate a bi-directional constant impedance pole/zero pi form filter in single ended and balanced forms according to one embodiment of the present invention. Circuit 900 includes inductors 901 and 902, resistors 903, 904, 905 and 907, capacitors 906 and 908, input lines 920 and 922, and output lines 924 and 926. In one embodiment, inductor 901, resistor 904 and inductor 902 and resistor 903, coupled in series, are coupled in parallel between a first node A9 and a second node B9. Resistor 905 and capacitor 906 are coupled in series between the first node A9 and a third node c9. Resistor 907 and capacitor 908 are coupled in series between the second node B9 and the third node c9. Input line 920 is coupled to the first node A9, input line 922 is coupled to the third node c9, output line 924 is coupled to the second node B9, and output line 926 is coupled to the third node c9.

In one embodiment, the values of the components in circuit 900 may be chosen as follows. The value of the first resistor 905 equals the value of the fourth resistor 907 which equals:

$$R 1 = R 4 = \frac{k + 1}{k - 1} \cdot {z}_{0} \qquad ( 15 )$$

where z₀ is the constant input impedance and k is the ratio of the zero frequency to the pole frequency, where k has a value greater than one.
The value of the second resistor 903 equals:

$$R 2 = 2 \cdot \frac{k + 1}{k - 1} \cdot {z}_{0} \qquad ( 16 )$$

The value of the third resistor 904 equals:

$$R 3 = \frac{( {k}^{2} - 1 )}{2 k} \cdot {z}_{0} \qquad ( 17 )$$

The value of the first inductor 901 equals:

$$L 1 = \frac{( k - 1 )}{k} \cdot \frac{{z}_{0}}{{ω}_{c}} \qquad ( 18 )$$

where ω_{c} is the desired pole frequency.
The value of the second inductor 902 equals:

$$L 2 = \frac{{( k + 1 )}^{2}}{k ( k - 1 )} \cdot \frac{{z}_{0}}{{ω}_{c}} \qquad ( 19 )$$

The value of the first capacitor 906 equals the value of the second capacitor 908 which equals:

$$C 1 = C 2 = \frac{( k - 1 )}{2 k} \cdot \frac{1}{{z}_{0} \cdot {ω}_{c}} \qquad ( 20 )$$

These values result in a transfer response (H(s)) for the filter as shown in equation 21.

$$H ( s ) = \frac{1 + \frac{s}{k \cdot {ω}_{c}}}{1 + \frac{s}{{ω}_{c}}} = \frac{s + k \cdot {ω}_{c}}{k ( s + {ω}_{c} )} \qquad ( 21 )$$

The filter is bi-directional and thus, the input impedance looking into the filter from either direction is equal to z₀. This is a constant input impedance value and, therefore, it is not dependent on the filter response.

This allows multiple LPF sections to be used in cascade with complete freedom to set any of the pole frequencies arbitrarily without interaction.

Referring to FIG. 9B, circuit 950 includes inductors 951, 952, 959 and 960, resistors 953, 954, 955, 957, 961 and 962, capacitors 956 and 958, input lines 970 and 972, and output lines 974 and 976. In one embodiment, inductor 951, resistor 954 and inductor 952 and resistor 953, coupled in series, are coupled in parallel between a first node A9 and a second node B9. Resistor 955 and capacitor 956 are coupled in series between the first node A9 and a third node c9. Resistor 957 and capacitor 958 are coupled in series between the second node B9 and a fourth node D9. Inductor 959, resistor 962 and inductor 960 and resistor 961, coupled in series, are coupled in parallel between the third node c9 and the fourth node D9. Input line 970 is coupled to the first node A9, input line 972 is coupled to the third node c9, output line 974 is coupled to the second node B9, and output line 976 is coupled to the fourth node D9.

In one embodiment, the values of the components in circuit 950 may be chosen in a manner similar to that discussed above with respect to FIG. 9A. The component values for FIG. 9B will be similar to those in FIG. 9A with several exceptions. Inductors 951 and 959 have an inductance value that is one half the value of inductor 901. Inductors 952 and 960 have inductance values equal to the one half the value of inductor 902. Resistors 953 and 961 have resistance values equal to one half the value of resistor 903. Resistors 954 and 962 have resistance values that equal to one half the value of resistor 904. The values of resistors 955 and 957 and capacitors 956 and 958 remain the same as components 905, 907, 906 and 908 respectively. Given these component values, the transfer function will be the same as shown above in equation 21.

In alternative embodiments, for values of k near one, L2 and R2 can be eliminated with negligible effect. This reduces the component count in FIG. 9A to 6. Similarly, in FIG. 9B, L2, R2, L4 and R5 may be eliminated, thereby reducing the component count to 8.

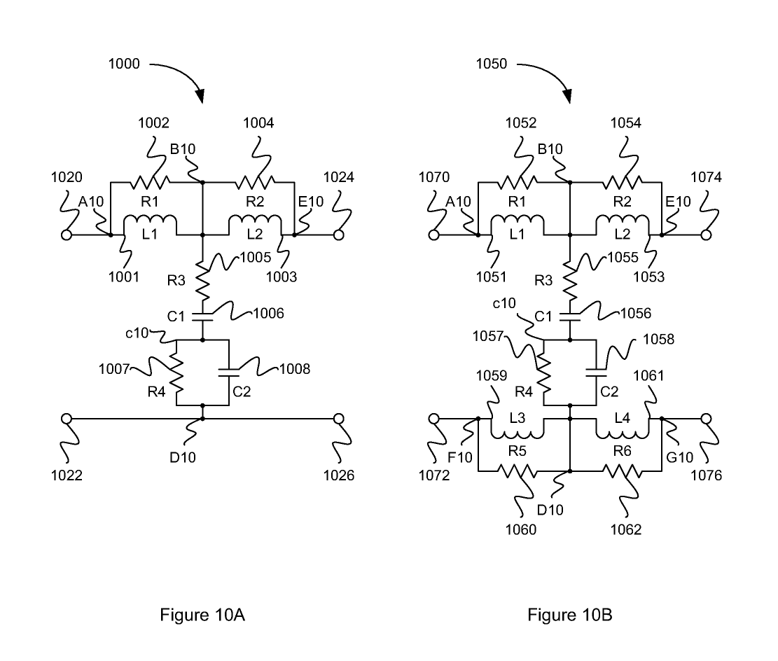

FIGS. 10A and 10B illustrate a bi-directional constant impedance pole/zero tee form filter in single ended and balanced forms according to one embodiment of the present invention. Circuit 1000 includes inductors 1001 and 1003, resistors 1002, 1004, 1005 and 1007, capacitors 1006 and 1008, input lines 1020 and 1022, and output lines 1024 and 1026. In one embodiment, inductor 1001 and resistor 1002 are coupled in parallel between a first node A10 and a second node B10. Resistor 1005 and capacitor 1006 are coupled in series between the second node B10 and a third node c10. Resistor 1007 and capacitor 1008 are coupled in parallel between the third node c10 and a fourth node D10. Inductor 1003 and resistor 1004 are coupled in parallel between the second node B10 and a fifth node E10. Input line 1020 is coupled to the first node A10, input line 1022 is coupled to the fourth node D10, output line 1024 is coupled to the fifth node E10, and output line 1026 is coupled to the fourth node D10.

In one embodiment, the values of the components in circuit 1000 may be chosen as follows. The value of the first resistor 1002 equals the value of the second resistor 1004 which equals:

$$R 1 = R 2 = \frac{k - 1}{k + 1} \cdot {z}_{0} \qquad ( 22 )$$

where z₀ is the constant input impedance and k is the ratio of the zero frequency to the pole frequency where k has a value greater than one.
The value of the third resistor 1005 equals:

$$R 3 = \frac{2 k}{{k}^{2} - 1} \cdot {z}_{0} \qquad ( 23 )$$

The value of the fourth resistor 1007 equals:

$$R 4 = \frac{k - 1}{k + 1} \cdot \frac{{z}_{0}}{2} \qquad ( 24 )$$

The value of the first inductor 1001 equals the value of the second inductor 1003 which equals:

$$L 1 = L 2 = \frac{k - 1}{k} \cdot \frac{{z}_{0}}{2 \cdot {ω}_{c}} \qquad ( 25 )$$

where ω_{c} is the desired pole frequency.
The value of the first capacitor 1006 equals:

$$C 1 = \frac{k - 1}{k} \cdot \frac{1}{{z}_{0} \cdot {ω}_{c}} \qquad ( 26 )$$

The value of the second capacitor 1008 equals:

$$C 2 = \frac{{( k + 1 )}^{2}}{k ( k - 1 )} \cdot \frac{1}{{z}_{0} \cdot {ω}_{c}} \qquad ( 27 )$$

These values result in a transfer response (H(s)) for the filter as shown in equation 28.

$$H ( s ) = \frac{1 + \frac{s}{k \cdot {ω}_{c}}}{1 + \frac{s}{{ω}_{c}}} = \frac{s + k \cdot {ω}_{c}}{k ( s + {ω}_{c} )} \qquad ( 28 )$$

The filter is bi-directional and thus, the input impedance looking into the filter from either direction is equal to z₀. This is a constant input impedance value and, therefore, it is not dependent on the filter response.

This allows multiple LPF sections to be used in cascade with complete freedom to set any of the pole frequencies arbitrarily without interaction.

Referring to FIG. 10B, circuit 1050 includes inductors 1051, 1053, 1059 and 1061, resistors 1052, 1054, 1055, 1057, 1060 and 1062, capacitors 1056 and 1058, input lines 1070 and 1072, and output lines 1074 and 1076. In one embodiment, inductor 1051 and resistor 1052 are coupled in parallel between a first node A10 and a second node B10. Resistor 1055 and capacitor 1056 are coupled in series between the second node B10 and a third node c10. Resistor 1057 and capacitor 1058 are coupled in parallel between the third node c10 and a fourth node D10. Inductor 1053 and resistor 1054 are coupled in parallel between the second node B10 and a fifth node E10. Inductor 1059 and resistor 1060 are coupled in parallel between the fourth node D10 and a sixth node F10. Inductor 1061 and resistor 1062 are coupled in parallel between the fourth node D10 and a seventh node G10. Input line 1070 is coupled to the first node A10, input line 1072 is coupled to the sixth node F10, output line 1074 is coupled to the fifth node E10, and output line 1076 is coupled to the seventh node G10.

In one embodiment, the values of the components in circuit 1050 may be chosen in a manner similar to that discussed above with respect to FIG. 10A. The component values for FIG. 10B will be similar to those in FIG. 10A with several exceptions. Inductors 1051, 1053, 1059 and 1061 have an inductance value equal to one half the value of inductor 1001. Resistors 1052, 1054, 1060 and 1062 have resistance values equal to one half the value of resistor 1002. The values of resistors 1055 and 1057 and capacitors 1056 and 1058 remain the same as components 1005, 1007, 1006 and 1008 respectively. Given these component values, the transfer function will be the same as shown above in equation 28.

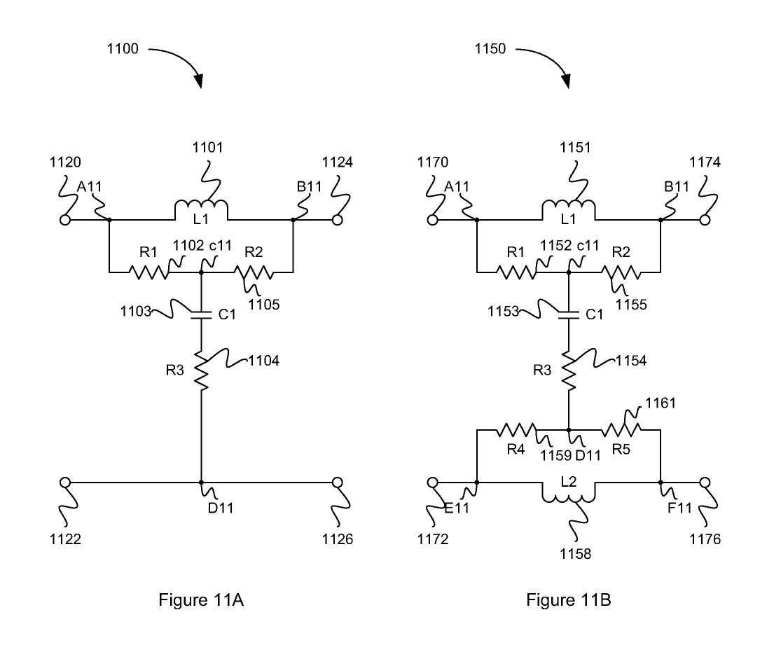

FIGS. 11A and 11B illustrate a bi-directional constant impedance pole/zero bridged-tee form filter in single ended and balanced forms according to one embodiment of the present invention. Circuit 1100 includes inductor 1101, resistors 1102, 1104, and 1105, capacitor 1103, input lines 1120 and 1122, and output lines 1124 and 1126. In one embodiment, inductor 1101 is coupled between a first node A11 and a second node B11. Resistor 1102 is coupled between the first node A11 and a third node c11. Capacitor 1103 and resistor 1104 are coupled in series between the third node c11 and a fourth node D11. Resistor 1105 is coupled between the second node B11 and the third node c11. Input line 1120 is coupled to the first node A11, input line 1122 is coupled to the fourth node D11, output line 1124 is coupled to the second node B11, and output line 1126 is coupled to the fourth node D11.

In one embodiment, the values of the components in circuit 1100 may be chosen as follows. The value of the first resistor 1102 equals the value of the second resistor 1105 which equals:

$$R 1 = R 2 = \frac{k - 1}{k + 1} \cdot {z}_{0} \qquad ( 29 )$$

where z₀ is the constant input impedance and k is the ratio of the zero frequency to the pole frequency where k has a value greater than one.
The value of the third resistor 1104 equals:

$$R 3 = \frac{2 k}{{k}^{2} - 1} \cdot {z}_{0} \qquad ( 30 )$$

The value of the first inductor 1101 equals:

$$L 1 = \frac{k - 1}{k} \cdot \frac{{z}_{0}}{{ω}_{c}} \qquad ( 31 )$$

where ω_{c} is the desired pole frequency.
The value of the first capacitor 1103 equals:

$$C 1 = \frac{k - 1}{k} \cdot \frac{1}{{z}_{0} \cdot {ω}_{c}} \qquad ( 32 )$$

These values result in a transfer response (H(s)) for the filter as shown in equation 33.

$$H ( s ) = \frac{1 + \frac{s}{k \cdot {ω}_{c}}}{1 + \frac{s}{{ω}_{c}}} = \frac{s + k \cdot {ω}_{c}}{k ( s + {ω}_{c} )} \qquad ( 33 )$$

The filter is bi-directional and thus, the input impedance looking into the filter from either direction is equal to z₀. This is a constant input impedance value and, therefore, it is not dependent on the filter response.

This allows multiple LPF sections to be used in cascade with complete freedom to set any of the pole frequencies arbitrarily without interaction.

Referring to FIG. 11B, circuit 1150 includes inductors 1151 and 1158, resistors 1152, 1154, 1155, 1159 and 1161, capacitor 1153, input lines 1170 and 1172, and output lines 1174 and 1176. In one embodiment, inductor 1151 is coupled between a first node A11 and a second node B11. Resistor 1152 is coupled between the first node A11 and a third node c11. Capacitor 1153 and resistor 1154 are coupled in series between the third node c11 and a fourth node D11. Resistor 1155 is coupled between the second node B11 and the third node c11. Resistor 1159 is coupled between the fourth node D11 and a fifth node E11. Resistor 1161 is coupled between the fourth node D11 and a sixth node F11. Inductor 1158 is coupled between the fifth node E11 and the sixth node F11. Input line 1170 is coupled to the first node A11, input line 1172 is coupled to the fifth node E11, output line 1174 is coupled to the second node B11, and output line 1176 is coupled to the sixth node F11.

In one embodiment, the values of the components in circuit 1150 may be chosen in a manner similar to that discussed above with respect to FIG. 11A. The component values for FIG. 11B will be similar to those in FIG. 11A with several exceptions. Inductors 1151 and 1158 have an inductance value that is one half the value of inductor 1101. Resistors 1152, 1155, 1159 and 1161 have resistance values equal to one half the value of resistor 1102. The values of resistor 1154 and capacitor 1153 remain the same as components 1104 and 1103 respectively. Given these component values, the transfer function will be the same as shown above in equation 33.

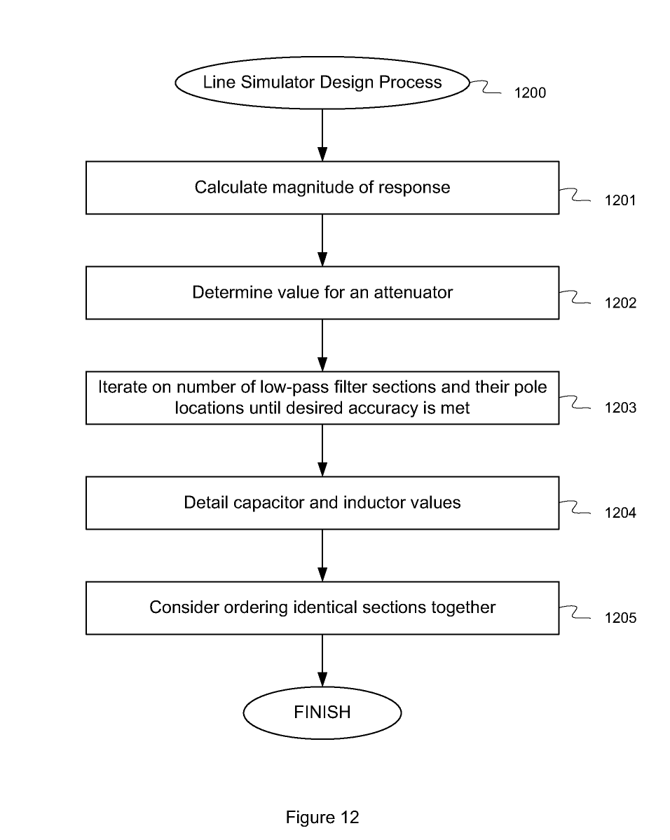

FIG. 12 is a flow diagram illustrating designing a line simulator according to one embodiment of the present invention. In one embodiment, line simulator design process 1200 is used to design a line simulator such as line simulator 400 of FIG. 4 which may be used to simulate a length of telecommunication line such as transmission medium 206 of FIG. 2. At block 1201, process 1200 calculates the magnitude of the response of length of telecommunication line being simulated. The transfer function of the telecommunication line represents the relation between the output and the input of the line. In one embodiment, the transfer function of the length of telecommunication line being simulated is calculated using formulas well-known to one of ordinary skill in the art. In an alternative embodiment, the transfer function is obtained by measuring the performance of the actual length of telecommunication line.

At block 1202, process 1200 determines a value for an attenuator to be included in the line simulator. In one embodiment, the attenuator has an attenuation factor of 6.9 dB, as described above with respect to FIG. 4. Once the transfer function of the length of telecommunication line is determined at the attenuator value chosen, the number of low pass sections required and their pole locations are determined. At block 1203, process 1200 iterates on both the number of LPF sections and their pole locations until an overall response curve is obtained which fits the target response to within a given threshold. In one embodiment, the desired accuracy is 3 dB, but in alternative embodiments, the desired accuracy is some other value. In one embodiment a mathematics computation program is used to determine whether the desired accuracy is met. In an alternative embodiment, a filter design program that is capable of curve fitting first order low-pass sections is used.

At block 1204, process 1200 details the values of the capacitors and inductors in the LPF section design. Since the input impedance is constant and already known, the capacitor and inductor values for each LPF section will depend solely on the pole location of that section. In one embodiment, the input impedance will be approximately 100 ohms. In one embodiment, the values of the capacitors and inductors in the LPF design for each section are obtained through the formulas discussed above with respect to FIGS. 5A, 5B and 7A-11B.

At block 1205, process 1200 considers the ordering of the LPF sections in the simulator design. Since the sections are in cascade and are symmetric, they may be placed in any order. However, in one embodiment, identical sections (i.e. LPF sections having the same pole location and component values) are ordered together so that their equal shunt resistances and capacitances are combined into one resistor in series with one capacitor. This serves to further reduce the total component count in the simulator design. After the sections have been properly ordered, the design is complete and process 1200 ends.

The filter structures and first order constant impedance topologies discussed herein may have utility in other filtering applications not related to telecommunication line simulation. In alternative embodiments, the filter structures may be used for compensation of digital transmission lines implemented as printed circuit board traces.

In one embodiment, the methods described above may be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, or any type of media suitable for storing electronic instructions. The information representing the apparatuses and/or methods stored on the machine-readable medium may be used in the process of creating the apparatuses and/or methods described herein.

While some specific embodiments of the invention have been shown the invention is not to be limited to these embodiments. The invention is to be understood as not limited by the specific embodiments described herein, but only by the scope of the appended claims.

What is claimed is:

1. A method comprising:
providing one or more bi-directional constant input impedance filters; and
simulating a length of telecommunications line using the one or more filters.

2. The method of claim 1, wherein simulating the length of telecommunications line comprises approximating a transfer function of the length of telecommunications line.

3. The method of claim 2, wherein approximating the transfer function comprises generating a response that approximates a target response of the transfer function to within a given threshold.

4. The method of claim 2, wherein one of the one or more filters comprises a low-pass filter.

5. The method of claim 4, wherein the low-pass filter comprises a pi form filter, a tee form filter or a bridged-tee form filter.

6. The method of claim 2, wherein one of the one or more filters comprises a pole/zero filter.

7. The method of claim 6, wherein the pole/zero filter comprises a pi form filter, a tee form filter or a bridged-tee form filter.

8. The method of claim 3, wherein identical components are used jointly by adjacent filters.

9. The method of claim 1, wherein the constant input impedance is approximately 100 ohms.

10. The method of claim 1, further comprising attenuating an output of the one or more filters.

11. An apparatus comprising:
a telecommunications line simulator having bi-directional constant input impedance.

12. The apparatus of claim 11, wherein the telecommunications line simulator comprises:
one or more bi-directional constant input impedance filters; and
an attenuator coupled in series to the one or more filters.

13. The apparatus of claim 12, wherein one of one or more filters comprises a first-order low-pass filter.

14. The apparatus of claim 12, wherein the first-order low-pass filter comprises a pi form filter, a tee form filter, or a bridged-tee form filter.

15. The apparatus of claim 14, wherein the bridged-tee form filter comprises:
a first inductor coupled between a first node and a second node;
a first resistor coupled between the first node and a third node;
a first capacitor coupled between the third node and a fourth node; and
a second resistor coupled between the second node and the third node.

16. The apparatus of claim 15, wherein the bridged-tee form filter further comprises:
a third resistor coupled between the fourth node and a fifth node;
a fourth resistor coupled between the fourth node and a sixth node; and
a second inductor coupled between the fifth node and the sixth node.

17. The apparatus of claim 12, wherein one of the one or more filters comprises a pole/zero filter.

18. The apparatus of claim 17, wherein the pole/zero filter comprises a pi form filter, a tee-form filter or a bridged-tee form filter.

19. The apparatus of claim 18, wherein the bridged-tee form filter comprises:
a first inductor coupled between a first node and a second node;
a first resistor coupled between the first node and a third node;
a second resistor coupled between the second node and the third node; and
a first capacitor and a third resistor coupled in series between the third node and a fourth node.

20. The apparatus of claim 19, wherein the bridged-tee form filter further comprises:
a fourth resistor coupled between the fourth node and a fifth node;
a fifth resistor coupled between the fourth node and a sixth node; and
a second inductor coupled between the fifth node and the sixth node.

21. The apparatus of claim 12, wherein identical components are used jointly by adjacent filters.

22. The apparatus of claim 11, wherein the constant input impedance is approximately 100 ohms.

23. An apparatus comprising:
a plurality of electric components; and
means for simulating a behavior of a length of telecommunications line using the plurality of electric components in a ratio of less than five electric components for every 50 feet of the telecommunications line being simulated.

24. The apparatus of claim 23, wherein the means for simulating the length of telecommunications line comprises means for approximating a transfer function of the length of telecommunications line.

25. The apparatus of claim 23, wherein the means for simulating the length of telecommunications line comprises means for simulating a plurality of line lengths.

26. The apparatus of claim 23, wherein the means for simulating the length of telecommunications line comprises a modular design made for selectable line lengths.

27. A method comprising:
providing a length of telecommunications line to be simulated; and
designing a bi-directional constant input impedance line simulator to simulate a behavior of the length of telecommunications line.

28. The method of claim 27, wherein designing the bi-directional constant input impedance line simulator comprises:
calculating a target response of the length of telecommunications line;
determining a value for an attenuator in the line simulator;
determining a number of filter sections in the line simulator and pole locations associated with the filter sections;
determining values of a plurality of components in the filter sections; and
determining an order of the filter sections and the attenuator in the line simulator.

29. The method of claim 28, wherein an actual response of the line simulator approximates the target response of the line length of telecommunications line to within a given threshold.
